(19) United States
(12) Patent Application Publication
(10) Pub. No.: US 2007/0146872 A1
(43) Pub. Date: Jun. 28, 2007

(54) Invertible light-optical microscope

(75) Inventors: Thomas Bocher, Goettingen (DE); Hans Tandler, Jena (DE); Hubert Wahl, Stadtroda (DE); Hans Brinkmann, Goettingen (DE); Reiner Mitzkus, Goettingen (DE); Franz Muchel, Koenigsbronn (DE); Harald Schadwinkel, Hannover (DE); Peter Gretscher, Jena (DE)

Correspondence Address: REED SMITH, LLP;ATTN: PATENT RECORDS DEPARTMENT, 599 LEXINGTON AVENUE, 29TH FLOOR, NEW YORK, NY, 10022-7650, US

(73) Assignee: CARL ZEISS JENA GmbH, Jena (DE)

(21) Appl. No.: 10/578,287

(22) PCT Filed: Nov. 4, 2004
(86) PCT No.: PCT/DE04/02464

§ 371 Date: Feb. 12, 2007

(30) Foreign Application Priority Data
Nov. 7, 2003 (DE) 103 52 523.8

(51) Int. Cl. G02B 21/06

(52) U.S. Cl. 359/386

(57) ABSTRACT

An optical microscope can be converted by the user quickly with a few movements of the hand so that it can be used as an upright variant or as an inverted variant. The required optical elements are accommodated in components that can be mechanically separated from one another and variously combined. The optical system is calculated in such a way that an upright microscope with vertical illumination or transmitted illumination or an inverted microscope with vertical illumination or transmitted illumination results when the components are combined in the required manner by interfaces provided for this purpose.

### CROSS-REFERENCE TO RELATED APPLICATIONS

This application claims priority of International Application No. PCT/DE2004/002464, filed Nov. 4, 2004 and German Application No. 103 52 523.8, filed Nov. 7, 2003, the complete disclosures of which are hereby incorporated by reference.

### BACKGROUND OF THE INVENTION

a) Field of the Invention

The invention is directed to an optical microscope that can be converted by the user quickly and by a few movements of the hand for use as an upright microscope or as an inverted microscope. A microscope of this kind is known from the Laid Open Application DE 30 37 556 A1.

b) Description of the Related Art

Already in 1887, a patent was applied for in the U.S.A. for presumably the first invertible microscope and was published as U.S. Pat. No. 373,634. As can be seen clearly from FIG. 1 of this patent, an arm B is supported at a stand A so as to pivot around a horizontally extending axis of rotation. An illumination unit comprising a mirror M and optics arranged in front, a microscope stage I, and an imaging unit comprising an objective j and a tube F are mounted indirectly at the arm B at a fixed distance from one another.

In order to use the inverted variant of the microscope (indicated by solid lines), a deflecting prism is located in the imaging beam path between the tube and the objective. The arm is in a position in which the illumination unit is arranged above the object stage and the objective is arranged below the object stage.

To convert to the upright variant the arm is pivoted by 180°, the deflecting prism is removed, and the tube is fastened in the extended objective axis. The object stage which is fastened to the arm by a plug-in connection is rotated and fastened again to the arm in the same position.

DE 30 37 556 likewise discloses an optical microscope which can be used either as an upright microscope or as an inverted microscope. An imaging system and an illumination system are accommodated in a housing with external guide elements. The enclosed systems are inserted into a base frame at a defined distance one above the other by means of the guide elements. The imaging system is located above the illumination system for the upright variant and below the illumination system for the inverted variant. Different illumination systems and imaging systems can be associated with one another. However, in this case, they produce a microscope with transmitted illumination, as is also disclosed in U.S. Pat. No. 373,634.

Invertible microscopes working with both vertical illumination and transmitted illumination are not known from the prior art.

Non-invertible microscopes, that is, either upright microscopes or inverted microscopes, that work with reflected light as well as transmitted light are known, for example, from U.S. Pat. No. 4,210,384. As in the solutions already mentioned above, an illumination unit is arranged opposite to and in line with the objective for vertical illumination. Their required distance relative to one another and relative to an object stage located therebetween is determined by the parameters of the optical systems and is selected in such a way that the object plane is illuminated in an optimal manner and the object is sharply imaged. The illumination system and the imaging system form two mechanically separate assemblies so that the observation beam path and the illumination beam path extend spatially separate from one another.

To work with transmitted light, the illumination beam path and the imaging beam path are brought together, i.e., some optical elements are used in common by both beam paths. In so doing, either the illumination beam path is coupled into the observation beam path by an optically semitransparent deflecting element or, as in U.S. Pat. No. 4,210,384, the observation beam path is coupled into the illumination beam path. The microscope disclosed in this reference cannot be converted to an inverted microscope.

### OBJECT AND SUMMARY OF THE INVENTION

It is the primary object of the invention to provide an invertible optical microscope which can work as an upright microscope and alternately as an inverted microscope with reflected light and transmitted light. The resulting four microscope variants, namely, an upright variant with reflected light, an upright variant with transmitted light, an inverted variant with reflected light, and an inverted variant with transmitted light, can be assembled by the user with a few movements of the hand and without adjustment. In an advantageous manner, all components are used for each variant.

The above-stated object is met, according to the invention, by an invertible optical microscope which can be assembled as an upright variant or an inverted variant comprising a stand, a first imaging system comprising an objective and a tube, a first illumination system for vertical illumination comprising a lamp, a collector and a condenser, and an object stage which is located below the objective for the upright variant and above the objective for the inverted variant. The objective which is enclosed together with a beam-splitting deflecting element for incident light reflection is an objective module. The enclosed condenser is an illumination module. The first imaging system for implementing the upright variant is determined by the objective module, the tube and a first optical path lying between the tube and the objective module that is mounted above the object stage. A second imaging system is provided for the inverted variant, which second imaging system is determined by the objective module, the tube, and a second optical path lying between the tube and the objective module that is mounted below the object stage. Optical elements present in the first optical path or second optical path are calculated in such a way that an imaging of an object by the first imaging system is identical to an imaging of the object by the second imaging system.

The essence of the invention consists in particular in that the optical components for implementing an upright variant or an inverted variant with vertical illumination or transmitted illumination are accommodated in components which can be separated from one another mechanically. The interfaces of the components are situated in the infinite beam path and lie between two optically imaging elements so that by altering the arrangement of the components relative to one another in a simple manner and adding or omitting components the user is able to change the geometric path length and the course of the imaging beam path and illumination beam path in order to operate the microscope alternately as an upright microscope or as an inverted microscope with transmitted illumination or vertical illumination.

Some embodiment examples of the invention are described in more detail in the following with reference to drawings.

### BRIEF DESCRIPTION OF THE DRAWINGS

In the drawings:

FIG. 1a is a schematic diagram of the upright variant of a first embodiment example with a tube in back;

FIG. 1b is a schematic diagram of the inverted variant of the embodiment example according to FIG. 1a;

FIG. 2a is a schematic diagram of the upright variant of a second embodiment example with the tube in front;

FIG. 2b is a schematic diagram of the inverted variant of the embodiment example according to FIG. 2a;

FIG. 3a is a schematic diagram of the upright variant of a third embodiment example with the tube in front;

FIG. 3b is a schematic diagram of the inverted variant of the embodiment example according to FIG. 3a;

FIG. 4a is a schematic diagram of the upright variant of a fourth embodiment example with an L-shaped stand;

FIG. 4b is a schematic diagram of the inverted variant of the embodiment example according to FIG. 4a;

FIG. 5a is a schematic diagram of the upright variant of a fifth embodiment example with a reversible stand; and

FIG. 5b is a schematic diagram of the inverted variant of the embodiment example according to FIG. 5a.

### DESCRIPTION OF THE PREFERRED EMBODIMENTS

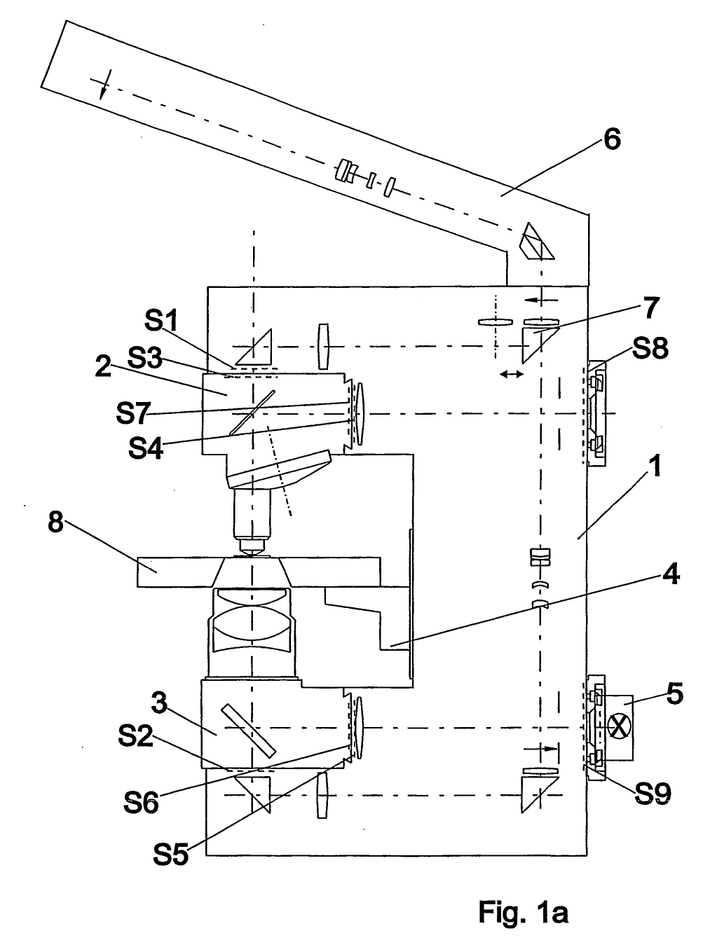

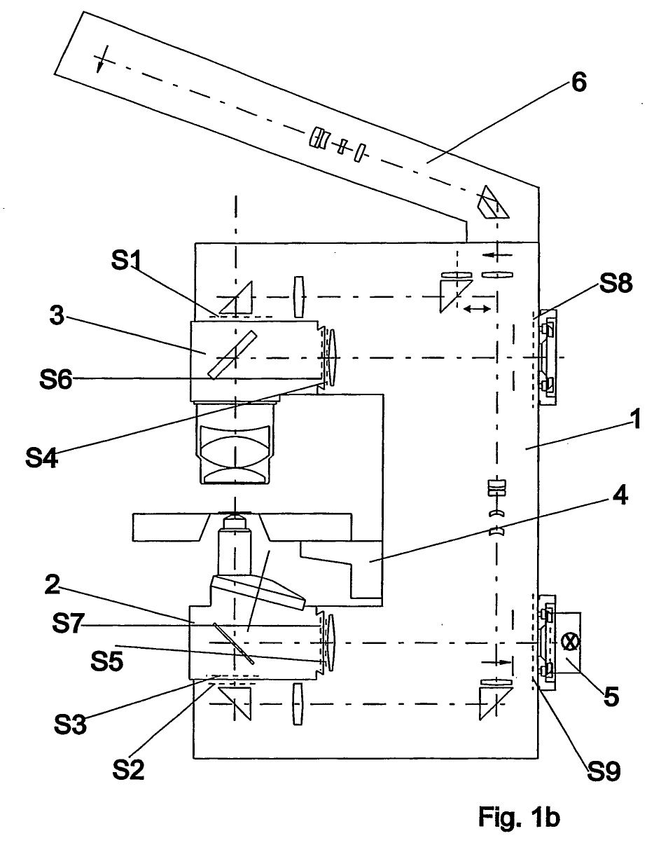

FIGS. 1a and 1b show a first embodiment example for an optical microscope according to the invention. It substantially comprises the following components: stand 1, objective module 2, illumination module 3, object stage carrier 4, lamp 5, and tube 6. The combination of components shown in FIG. 1a gives the upright variant of a first embodiment example using transmitted illumination. FIG. 1b shows the inverted variant with vertical illumination.

The stand 1 is hollow and C-shaped. One of the sides of the ‘C’ (the bottom side) forms the stand base 13. The two (bottom and top) sides have rectangular recesses at their free ends facing one another. A top imaging interface S1, a top illumination interface S4, a bottom imaging interface S2, and a bottom illumination interface S5 are located at the planes of the recesses defining the stand 1. A top lamp interface S8 and a bottom lamp interface S9 which are parallel to and at the same height as the top and bottom illumination interfaces S4, S5 are provided on the opposite outer side of the stand 1.

A complete illumination system for the transmitted illumination of the upright variant (FIG. 1a) is formed by arranging the lamp 5 at the bottom lamp interface S9 and the illumination module 3 at the bottom illumination interface S5. When arranging the lamp 5 at the top lamp interface S8 and the illumination module 3 at the top illumination interface S4, the optical paths between the illumination interfaces S4, S5 and the lamp interfaces S8, S9 are identical so that an optically identical illumination system results for the transmitted illumination of the inverted variant.

In order to form an illumination system for transmitted illumination, the lamp 5 is fastened to one of the lamp interfaces S8, S9 and the objective module 2 is fastened to the opposite illumination interface S5, S4, respectively. The interfaces are indicated in the drawings by dashed lines, each comprehending a physical edge. In reality, the interfaces have direct mechanical contact with one another and they coincide optically, i.e., they lie in a plane. Correspondingly, the same optical ratios apply to both. The interfaces mentioned above are located in an area of the imaging beam path or illumination beam path with a parallel beam course.

The illumination interfaces S4, S5 are brought together with an illumination-side illumination interface S6 for a vertical illumination system on the one hand and with an objective module-side illumination interface S7 for a transmitted illumination system on the other hand. In a corresponding manner, the vertical illumination system and the transmitted illumination system must be calculated in such a way that the optical ratios in the illumination interface S6 on the microscope side are identical to the optical ratios in the illumination interface S7 on the objective module side.

The object stage carrier 4 is arranged at the stand 1 so as to be vertically displaceable, i.e., focusable, so as to displace the support plane of an object stage 8 fastened thereto in the object plane of the objective. The object stage 8 has an opening in the center for inserting different object holders or other inserts such as Petri dishes or microtiter plates so that it is suitable for vertical illumination and for transmitted illumination.

The objective module 2, which comprises, in addition to the objective, an incident light reflector with a beam-splitting deflecting element, communicates by its imaging interface S3 on the objective module side with the top imaging interface S1 for the upright variant and with the bottom imaging interface S2 for the inverted variant.

In a corresponding manner, the optical elements of the objective module 2 and of the tube 6 in connection with the optical elements in the top side (first optical path) of the stand 1 form the imaging system for the upright variant and in connection with the optical elements in the bottom side and the side connection (second optical path) form the imaging system for the inverted variant. In order to achieve the same imaging ratios for both variants, i.e., to offer identical imaging to the observer, the imaging interfaces S1, S2, S3 must lie in conjugate planes relative to one another when the two imaging systems are considered jointly. A deflecting element 7 is added to or removed from the beam path by means of an operator control located at the stand 1 so that the object imaging is carried out depending on the arrangement of the objective module 2 in the tube 6. In the inverted variant, the image transmission to the intermediate image of the eyepiece in the tube 6 is carried out by way of two image transmission systems (triplets) in which two intermediate image planes result in each instance in the coinciding image planes of the adjacent imaging elements. The second intermediate image plane in the imaging direction is the first intermediate image plane for the upright variant.

In the areas of the mechanical interfaces that are determined by outer contact surfaces of the components, the stand 1 comprises a metal-ceramic material, a metal alloy, or a composite material with high dimensional stability and excellent resistance to wear. The mechanical connection of the interfaces is advantageously implemented by means of slide guides so that the objective module 2 and the illumination module 3 can be fastened to the stand 1 only in an angular position. The slide groove and slide spring forming a connection, respectively, are arranged at the stand 1 and at the objective module 2 and illumination module 3 in such a way that the offset of the optical axis is very slight. By means of a one-sided contact of the slide spring at the slide groove by means of screwing or clamping, the play in the slide guide is eliminated and a reproducible positioning of the objective module 2 and illumination module 3 at the stand 1 which does not permit the parts connected to one another to rotate is ensured. Tolerances with respect to positioning in the direction of the slide guide have no influence on the imaging quality. Accordingly, it is particularly advantageous that the interfaces are formed by slide guides. However, they can also be realized by means of other snap-in connections which are familiar to the person skilled in the art and which permit only one or two relative positions relative to one another.

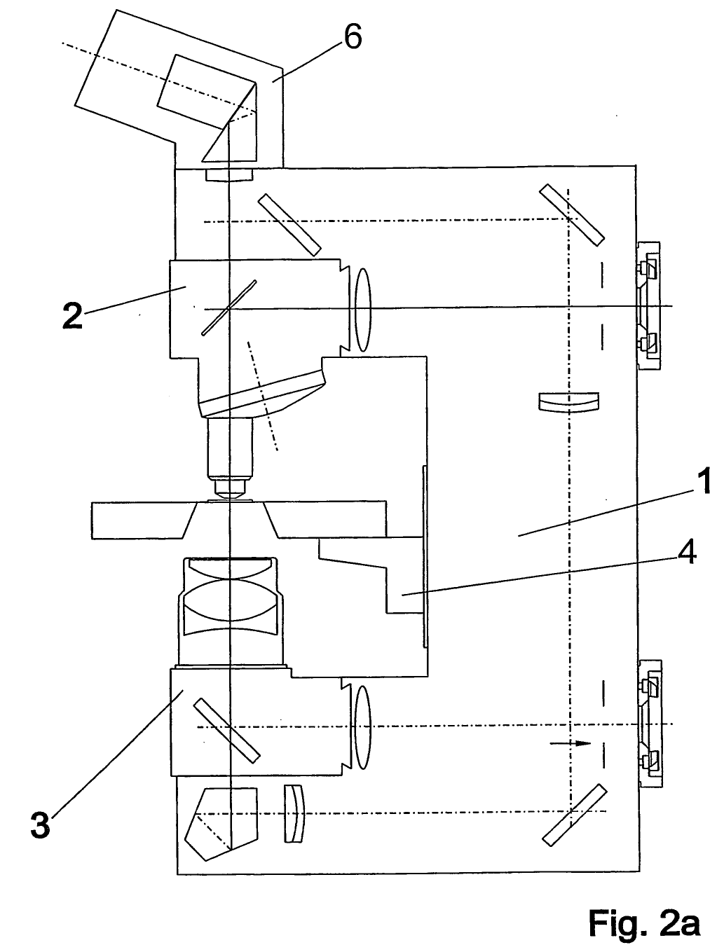

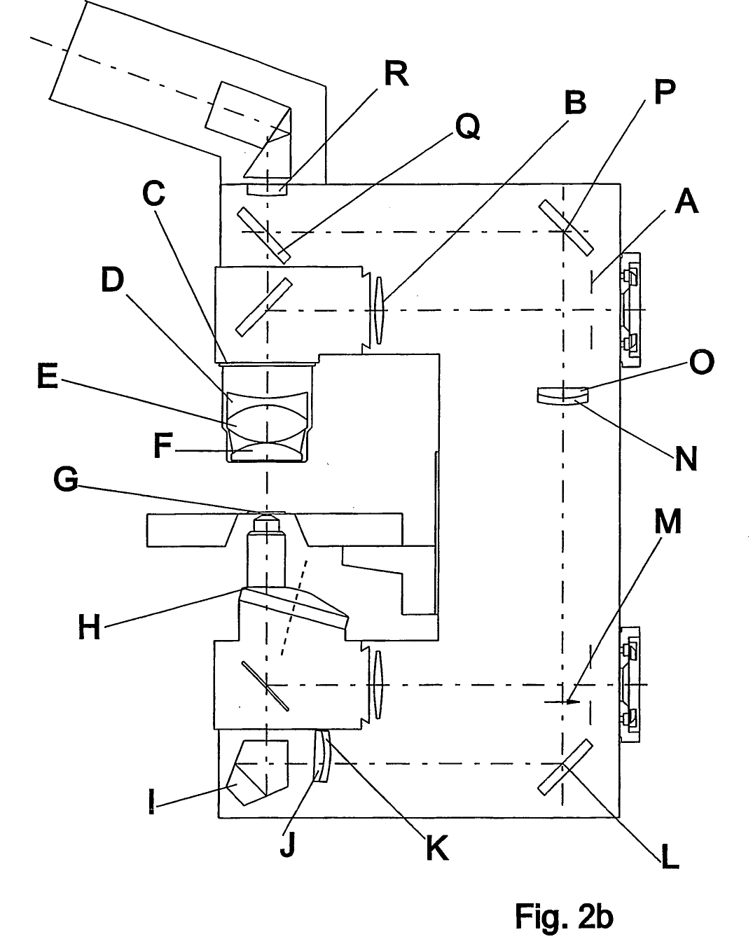

A second embodiment example, shown in FIGS. 2a and 2b, differs from the first embodiment example essentially in that the tube 6 is mounted on the stand 1 at the front rather than at the back from the point of view of the operator of the microscope. A construction of this kind is particularly advantageous when an invertible microscope is not required from the start, but rather when an upright microscope that can be converted in this sense is required. An inversion module containing the additional optical elements required for the inverted variant can be introduced, as needed, over the back wall or a side wall in the stand 1. The required optical elements can also be located at an interchangeable back wall.

In this embodiment example, the transmission optics for the inverted variant are 4f optics, as they are called, which are constructed as an afocal sequence of two relay optics and a tube lens. The intermediate image in the focal point M of the first relay optics J/K is received through the second relay optics N/O, imaged at infinity, and then imaged through the tube lens in the intermediate image plane of the eyepiece. The image-side focal point of the first relay optics coincides with the object-side focal point of the second relay optics. Also used are a penta prism I, two stationary deflecting elements L, P, and a deflecting element Q which is displaceable in the beam path by means of an operator control located at the stand 1. The displaceable deflecting element Q is needed for switching between the upright variant and inverted variant.

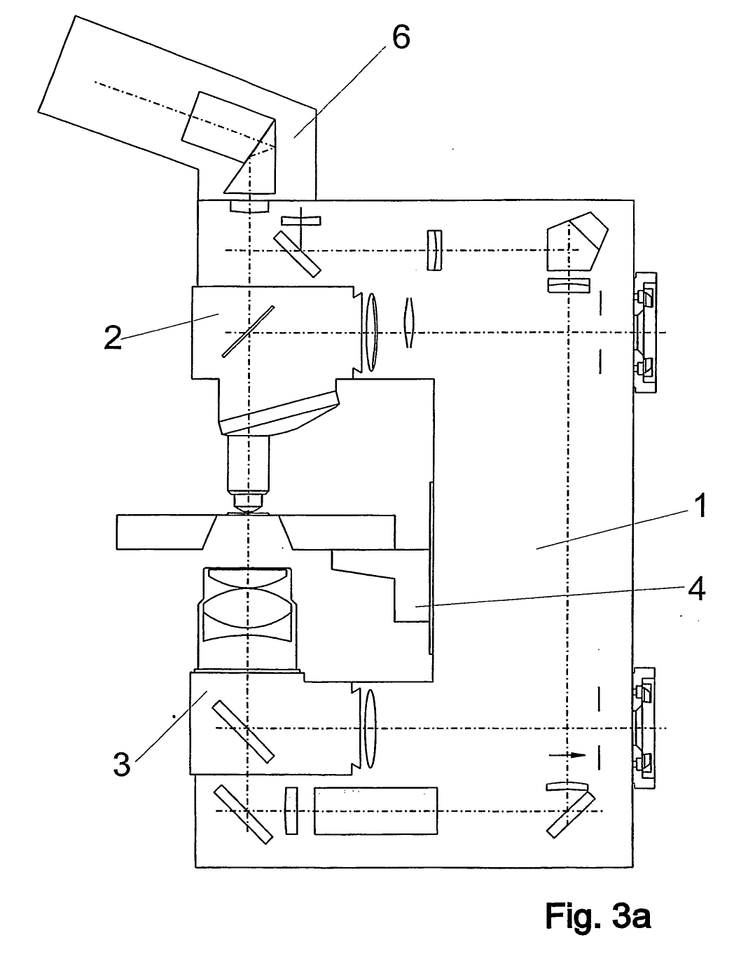

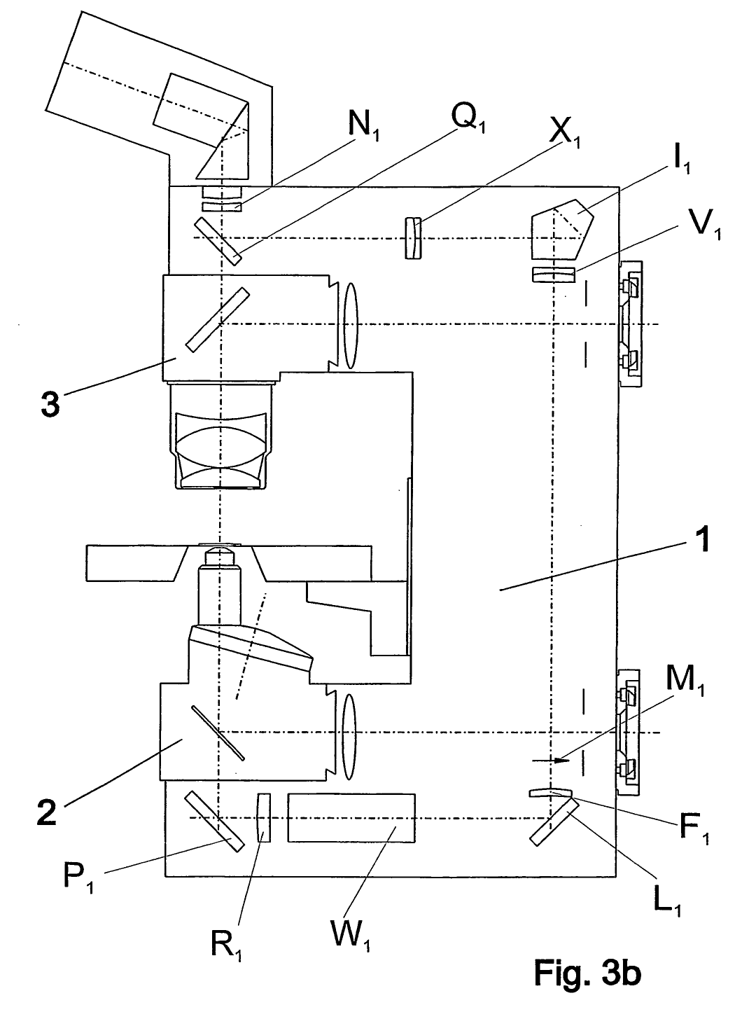

A third embodiment example shown in FIGS. 3a and 3b differs from the second embodiment example through the transmission optics which are provided for the inverted variant. For a favorable position of the intermediate image M, a glass block W₁ is used in this case following a stationary deflecting element P₁ and the tube lens R₁. This is followed by another stationary deflecting element L, a field lens F₁, an achromatic lens V₁, a penta prism I₁, and another achromatic lens x₁. A deflecting element Q₁ which is displaceable in the beam path is displaced together with the negative lens N₁ by an operator control located at the stand 1 in order to switch between the upright variant and the inverted variant.

The first three embodiment examples share the advantage that all components are always used for all variants. Only the objective module 2 and illumination module 3 need to be exchanged in order to convert from the upright variant to the inverted variant, and vice versa. The lamp 5 is mounted at one of two lamp interfaces S8, S9 to select between vertical illumination and transmitted illumination. It will be clear to the person skilled in the art that a variety of radiation sources commonly used in microscopy can be used as lamps 5.

The variable exchange of components is made possible in the three embodiment examples in particular in that the entire optical system is calculated in such a way that the pairs of interfaces—top and bottom imaging interfaces S1, S2, top and bottom illumination interfaces S4, S5, and top and bottom lamp interfaces S8, S9—are provided at the stand 1 and the pairs of interfaces have optically identical ratios.

Further, the imaging interfaces S1, S2 and the illumination interfaces S4, S5 are adapted to one another optically in order to achieve sharp imaging and optimal illumination of the object plane in reflected light by means of the objective module 2.

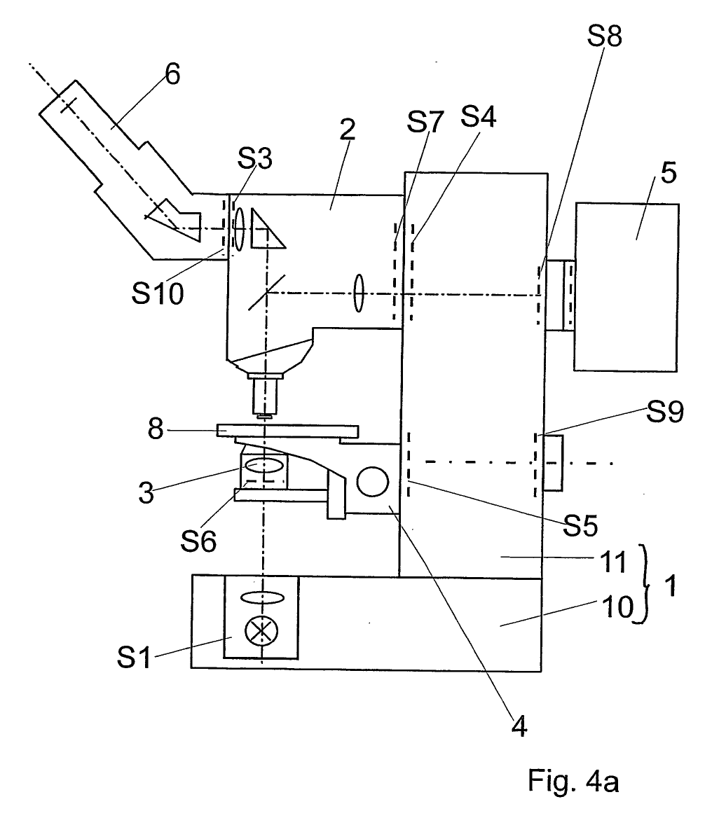

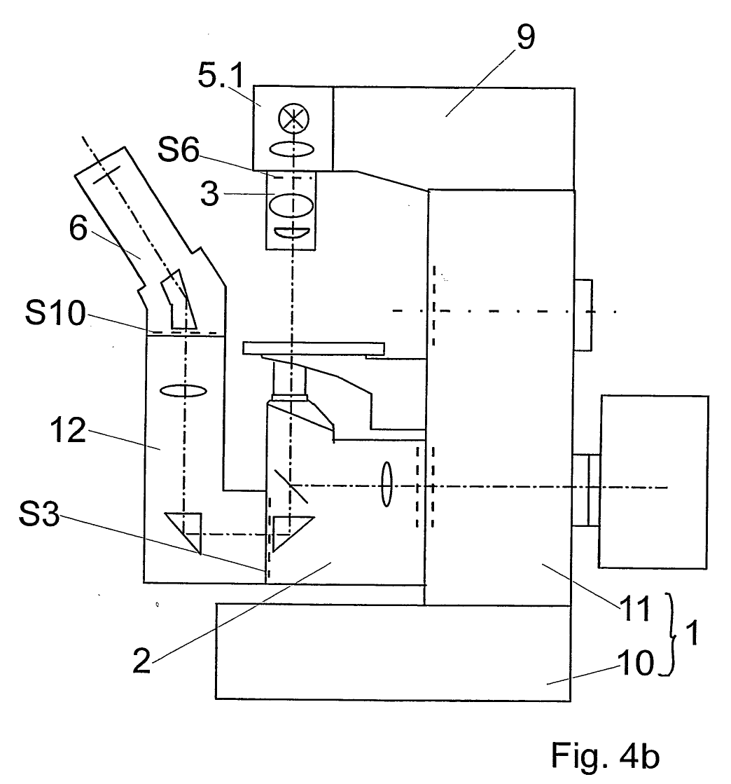

The fourth embodiment example, shown in FIGS. 4a and 4b, differs essentially in that the imaging beam path is not guided through the stand 1. The stand 1 comprises a base plate 10 and a stand pillar 11 which is erected vertically on the latter. The base plate is advantageously U-shaped so that the required operator controls can be arranged at an ergonomically favorable height.

In this case also, the objective module 2 can be fastened to the stand 1 for the two microscope variants by means of a top and a bottom illumination interface S4, S5. As in the embodiment examples described above, the lamp 5 can be positioned alternately at two locations at the stand 1; however, the lamp 5 in this fourth embodiment example serves only for vertical illumination. For transmitted illumination, a light source with a condenser lens which is arranged in the interior of the stand in the embodiment examples described above is to be arranged as a lamp assembly 5.1 in the base plate 10 or at a stand arm 9 so as to be in line with the objective. The illumination module 3 is arranged directly in front of the lamp assembly 5.1 for the inverted variant and is fastened to the object stage carrier 4 for the upright variant.

For the upright variant, the object imaging is carried out by means of the objective module 2 directly in the tube 6. For the inverted variant, an intermediate tube 12 is added between the objective module-side imaging interface S3 of the objective module 2 and the tube 6 which has a tube-side tube interface S10. In order to provide identical optical imaging ratios for the upright variant and inverted variant, the transmission optics in the intermediate tube 12 are calculated in such a way that they transmit the optical ratios in the imaging interface S3 on the objective module side into the tube interface S10 on the tube side in a ratio of 1:1.

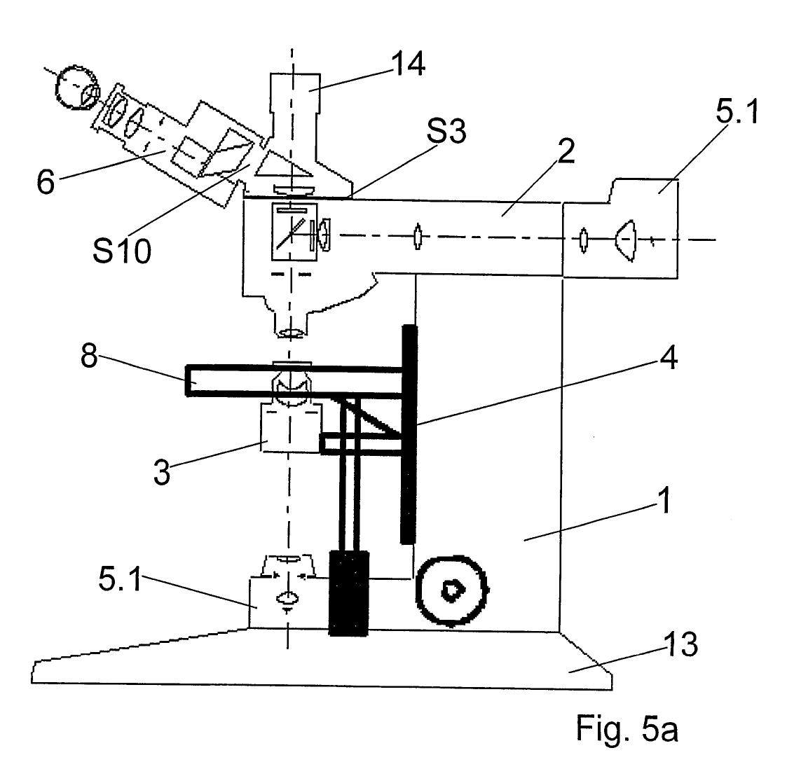

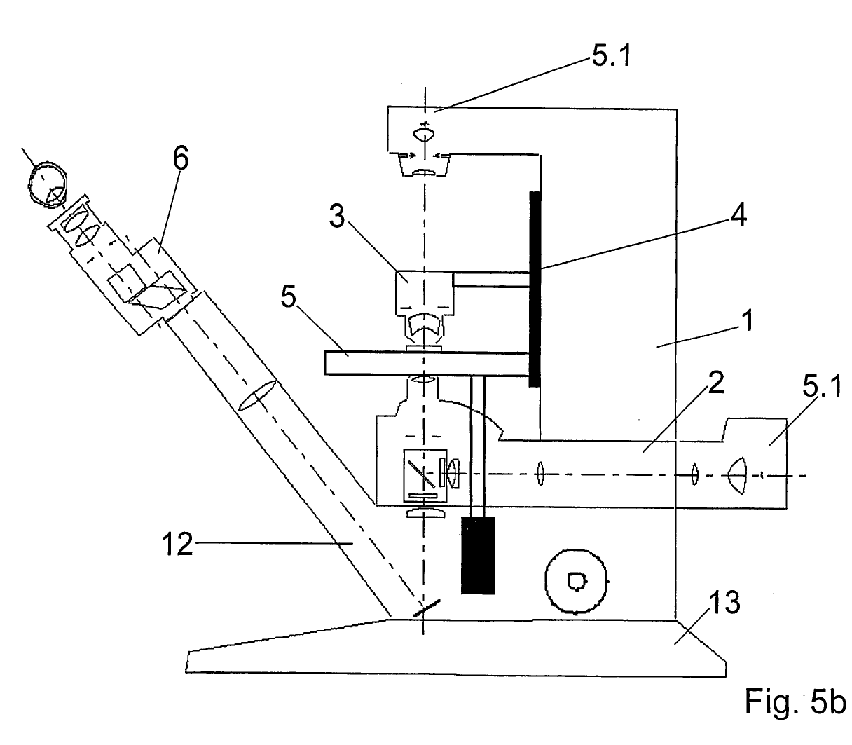

A fifth embodiment example according to the invention is described with reference to FIGS. 5a and 5b. In this case, the stand 1 is L-shaped. In the upright state of the stand 1 in the upright variant, shown in FIG. 5a, the base surface which is determined by the length and depth of the short side stands on a stand base 13. The objective module 2 is fixedly mounted to the overlap which is determined by the width and depth of the long side. In contrast to all of the embodiment examples described above, the microscope is converted from the upright variant to the inverted variant not by placing the objective module 2 at a different interface of the stand 1 but rather in that the stand 1 at which the objective module 2 is fixedly arranged is “stood on its head” so that the objective is located below or above the object stage 8.

For the upright variant, a trinocular tube that is formed by a tube 6 for visual observation and a camera tube 14 are attached to the imaging interface S3 on the objective module side.

For the inverted variant (FIG. 5b), an intermediate tube 12 which brings the eyepiece located at the tube 6 to an ergonomically favorable height for the user is arranged between the objective module 2 and the tube 6.

To provide identical optical imaging ratios for the upright variant and the inverted variant, the transmission optics in the intermediate tube 12 are calculated in such a way that they transform the optical ratios in the imaging interface S3 on the objective module side into the tube interface S10 on the tube side as takes place by means of the optical elements in the camera tube 14 which participate in the visually accessible imaging.

A lamp assembly 5.1 is connected directly to the objective module 2 for vertical illumination in the inverted variant. Together with the respective illumination module 3 which is arranged in front and is fastened to the object stage carrier 4, a second lamp assembly 5.1 which is accommodated in the short side of the stand 1 so as to be in line with the objective forms the illumination system for transmitted illumination.

The person skilled in the art of the field of the invention will appreciate that the invention is not limited to the details of the embodiment forms mentioned herein by way of example and that the present invention can be embodied in other specific forms without departing from the scope of the invention as set forth in the appended claims.

Reference Numbers

1 stand
2 objective module
3 illumination module
4 object stage carrier
5 lamp
5.1 lamp assembly
6 tube
7 deflecting element
8 object stage
9 stand arm
10 base plate
11 stand pillar
12 intermediate tube
13 stand base
14 camera tube
S1 top imaging interface
S2 bottom imaging interface
S3 imaging interface on the objective module side
S4 top illumination interface
S5 bottom illumination interface
S6 illumination interface on the illumination side
S7 illumination interface on the objective module side
S8 top lamp interface
S9 bottom lamp interface
S10 tube-side tube interface

1-7. (canceled)

8. An invertible optical microscope which can be assembled as an upright variant or as an inverted variant, comprising:
a stand;
a first imaging system comprising an objective and a tube;
a first illumination system for vertical illumination comprising a lamp, a collector, and a condenser; and
an object stage which is located below the objective for the upright variant and above the objective for the inverted variant;
said objective which is enclosed together with a beam-splitting deflecting element for incident light reflection being an objective module;
said enclosed condenser being an illumination module;
said first imaging system for implementing the upright variant being determined by the objective module, the tube, and a first optical path lying between the tube and the objective module that is mounted above the object stage;
a second imaging system being provided for the inverted variant, which second imaging system being determined by the objective module, the tube and a second optical path lying between the tube and the objective module that is mounted below the object stage; and
optical elements present in the first optical path or second optical path being calculated in such a way that an imaging of an object by the first imaging system is identical to an imaging of the object by the second imaging system.

9. The invertible microscope according to claim 8, wherein the objective module has an imaging interface on the objective module side and an illumination interface on the objective module side;
said illumination module having an illumination interface on the illumination side;
said objective module communicating with the stand by its objective interface on the objective module side alternately by a top imaging interface or a bottom imaging interface to use the microscope alternately as an upright microscope or as an inverted microscope;
said illumination module being connected to the stand by its illumination interface on the illumination side alternately by a top illumination interface or a bottom illumination interface so that, in connection with the lamp, it alternately makes available a vertical illumination for the upright variant of the microscope or the inverted variant of the microscope;
said objective module being fastened to the stand by its illumination interface on the objective module side by the respective free top illumination interface or bottom illumination interface;
a bottom lamp interface and a top lamp interface being provided opposite from the illumination interfaces, the lamp being attached alternately to this bottom lamp interface or top lamp interface in order to outfit both microscope variants alternately with vertical illumination or transmitted illumination;
said stand being hollow; and
the portions of the first imaging system and second imaging system lying between the tube and the top imaging interface or bottom imaging interface extending within the interior of the stand.

10. The invertible optical microscope according to claim 9, wherein the stand has the shape of a ‘C’, the first side of the ‘C’ forming the stand base, and the tube being mounted at the second side of the ‘C’; wherein both sides have, at their free end, rectangular recesses which face one another, the oppositely located surfaces in the recesses form the top and bottom imaging interfaces, and the surfaces perpendicular thereto form the top and bottom illumination interfaces.

11. The invertible optical microscope according to claim 8, wherein the objective module has an imaging interface on the objective module side and an illumination interface on the objective module side; wherein the objective module is connected to the stand by its illumination interface on the objective module side alternately by a top illumination interface or a bottom illumination interface; wherein the imaging interface on the objective module side alternately communicates with a tube-side tube interface of the tube directly or indirectly by an intermediate tube.

12. The invertible optical microscope according to claim 8, wherein the objective module is fixedly connected to the stand, and the stand is rotated by 180° with its base surface arranged upward in order to invert the upright variant into the inverted variant; wherein the objective module has, on the objective module side, an imaging interface that alternately connects indirectly via a camera tube or an intermediate tube to a tube-side tube interface located at the tube so that the first optical path is determined by the optical elements of the camera tube which participate in the visually accessible imaging and the second optical path is determined by the optical elements of the intermediate tube.

13. The invertible optical microscope according to claim 9, wherein the imaging interfaces, and the illumination interfaces are located in parallel beam paths.

14. The invertible optical microscope according to claim 11, wherein the imaging interfaces, and the illumination interfaces are located in parallel beam paths.
